(19) United States
(12) Patent Application Publication
(10) Pub. No.: US 2022/0384787 A1
(43) Pub. Date: Dec. 1, 2022

(54) AQUEOUS RECHARGEABLE BATTERY BASED ON FORMATION REACTION ANODES

(71) Applicant: THE BOARD OF TRUSTEES OF THE LELAND STANFORD JUNIOR UNIVERSITY, Stanford, CA (US)

(72) Inventor: John T. Mefford, Stanford, CA (US)

(73) Assignee: THE BOARD OF TRUSTEES OF THE LELAND STANFORD JUNIOR UNIVERSITY, Stanford, CA (US)

(21) Appl. No.: 17/762,016

(22) PCT Filed: Sep. 21, 2020
(86) PCT No.: PCT/US2020/051811

§ 371 Date: Mar. 18, 2022

Related U.S. Application Data
(60) Provisional application No. 62/903,614, filed on Sep. 20, 2019.

(51) Int. Cl. H01M 4/36; H01M 4/38; H01M 4/62; H01M 4/48; H01M 4/134; H01M 4/1395

(52) U.S. Cl. CPC H01M 4/366; H01M 4/387; H01M 4/625; H01M 4/483; H01M 4/134; H01M 4/1395; H01M 2004/027

(57) ABSTRACT

Provided herein are aqueous rechargeable batteries comprising: an anode including tin; a cathode; and an aqueous electrolyte disposed between the anode and the cathode. Other embodiments include methods of making a Sn anode material comprising forming tin oxide nanoparticlcs and coating the tin oxide nanoparticles with a conductive support.

### CROSS-REFERENCE TO RELATED APPLICATIONS

This application claims the benefit of and priority to U.S. patent application Ser. No. 62/903,614, filed on Sep. 20, 2019, the contents of which are incorporated herein in their entirety.

### BACKGROUND

Combating the challenge of climate change demands the focused efforts of the global community and the replacement of fossil fuels as the dominant energy generation source. Despite significant advancements in the development of clean renewable energy generation sources, such as photovoltaics and wind turbines, the transition to renewable energy has been slowed by ineffective ways of storing and distributing the energy generated through renewables. The rise of Li-ion batteries has demonstrated the promise of electrochemical methods of energy storage. However, the improvements in cost and energy density of battery technologies since the development of Li-ion battery based on a LiCoO₂ cathode and graphite anode have been marginal. In order to accelerate the transition from fossil fuels to renewables, beyond Li-ion technologies should be targeted. These include goals of improved battery chemistry and cell technologies for the transportation sector that lower costs to $80/kWh at the pack level, increase the energy density to 1 kWh/L, increase specific energy to 500 Wh/kg, and decrease charge times to 15 minutes or less. Ultimately, despite significant efforts in research and development, Li-ion intercalation-based batteries still fall short of these goals. Even with efforts to develop Li metal anodes, the capacities of Li-intercalating metal oxide cathodes will not reach these goals unless significantly improved chemistries are discovered. Aqueous rechargeable batteries are an attractive alternative. While they do not approach the operating voltages of Li-ion batteries due to the narrower stable voltage range of water, the electrode capacities can exceed those used in Li-ion batteries by using multi-electron conversion or formation electrodes. Benefits to this approach are significantly reduced cost, improved safety, and the potential for energy densities that exceed the best performing Li-ion intercalation batteries.

It is against this background that a need arose to develop the embodiments described herein.

### SUMMARY

Certain embodiments of the disclosure include an aqueous rechargeable battery comprising: an anode including tin; a cathode; and an aqueous electrolyte disposed between the anode and the cathode. In some embodiments, the anode includes shells encapsulating the tin. In some embodiments, the shells are carbonaceous shells. In some embodiments, the aqueous electrolyte is acidic. In some embodiments, the aqueous electrolyte has a pH in a range of about 1 to about 4. In some embodiments, the cathode includes manganese oxide.

Additional embodiments include a method of making a Sn anode material comprising forming tin oxide nanoparticles and coating the tin oxide nanoparticles with a conductive support. In some embodiments, the conductive support is a shell encapsulating the tin oxide. In some embodiments, the shell is a carbonaceous shell. In some embodiments, the shell is less than 10 nm thick. In some embodiments, the tin oxide nanoparticles are less than 100 nm in diameter.

### BRIEF DESCRIPTION OF THE DRAWINGS

FIG. 1 shows operation of a battery. During charging, electrons are move from the cathode to the anode through an external circuit. Cations in the electrolyte flow to the anode and anions flow to the cathode. The cell voltage (E_{cell}) is increased through this process. During discharging, the opposite phenomenon occurs and E_{cell} decreases. When the battery is fully discharged E_{cell}=0V.

FIG. 2 shows gravimetric Promise vs. raw material cost of abundant elements on Earth.

FIG. 3 shows specific capacity and voltage of select aqueous redox couples. The blue highlighted region represents the maximum voltage stability window for aqueous electrolytes and the dotted lines represent the standard potentials for the decomposition of water.

FIG. 4 shows a Mn—H₂O Pourbaix Diagram.

FIG. 5(a) shows a Pourbaix diagram for Fe—H₂O. FIG. 5(b) shows a Pourbaix diagram for Sn—H₂O. FIG. 5(c) shows a Pourbaix diagram for Co—H₂O.

FIG. 6 shows a calculation unit for energy and cost metrics of batteries at the pack level.

FIG. 7(a) shows voltage-pH relationship for the Sn—MnO₂ battery in acidic electrolytes and FIG. 7(b) shows voltage-p[Mn²⁺] relationship for the Sn—MnO₂ battery in acidic electrolytes.

FIG. 8 shows energy density versus cost to store energy for commercial and developing rechargeable battery technologies. Energy density and cost analysis was calculated through the approach reported by Wu et al.

FIG. 9 shows specific energy, energy density, and energy cost of Li-ion intercalation, Li-ion conversion, and aqueous rechargeable batteries. Anode chemistries of graphite (C), silicon (Si), and lithium (Li) are evaluated for the Li-ion battery systems and tin (Sn), zinc (Zn), and manganese (Mn) are evaluated for the aqueous systems.

FIG. 10(a) shows the optimal pH range is 1-4 for 2e⁻/Mn Cathode, and that it is likely a Mn anode is difficult unless electrolyte can be optimized to suppress H₂ reduction. FIG. 10(b) shows Optimal pH range is 8-12 for 2e⁻/Zn and no H₂ production through Zn dissolution, and H₂ reduction during ZnO reduction is still an issue. FIG. 10(c) shows the efficiency of H₂ reduction on Sn is less clear, but the plating potential very close to 0V vs. RHE so it's unlikely to be an issue.

FIG. 11 shows V vs. SHE at specific concentrations and pH of particular embodiments.

FIG. 12 a rechargeable acid battery (Si—MnO₂) embodiment.

FIG. 13 shows problems on the Sn anode (and solutions). Specifically, the SnO₂ is not conductive enough (band gap 3.6 eV [LiFePO₄ E_{g}=3.8-4.0V]) and prevents reversible cycling. One solution: Minimize size and encapsulate in conductive support Needs to accommodate volume change (133% for SnO₂ vs. Sn compared to 300% for Li_{4.4}Sn vs. Sn). The SnO₂ is not conductive enough (band gap 3.6 eV [LiFePO₄ E_{g}=3.8-4.0V]) and prevents reversible cycling. Another solution: dope with Sb (1%) to increase conductivity.

FIG. 14 shows Capacities and Voltages of Battery Electrodes, and that Aqueous cathodes have higher gravimetric capacities than Li-ion intercalating cathodes. Aqueous electrodes have much higher volumetric capacities (their densities are significantly higher).

### DETAILED DESCRIPTION

Embodiments of this disclosure relate to the use of tin metal as an anode in aqueous rechargeable batteries using the reaction Sn+2H₂O→SnO₂4H⁺4e⁻in acidic electrolytes or Sn+4OH⁻→SnO₂+2H₂O+4e⁻in alkaline electrolytes. The electrolyte is aqueous and the pH may range from highly acidic (pH less 0) to highly basic (pH greater than 14), but generally focused on weakly acidic electrolytes (pH=about 1-4). The tin (Sn) or tin oxide (SnO₂) particles may exhibit sizes ranging from the nanometer (about 1 nm, or more generally about 1 nm to about 1000 nm) to the micrometer scale (about 10 μm, or more generally about 1 μm to about 100 μm). Due to the transfer of 4 electrons per formula unit, the tin anode has a very high specific energy of about 900 mAh/g and energy density of about 6600 mAh/L which exceeds that of Li metal. In addition, given the abundance of Sn metal, it is expected that the price per energy unit stored for the Sn anode can be below 0.05$/Ah. As such it is expected that a rechargeable battery based on the Sn anode can exceed the important metrics for widespread adoption of renewables. Many cathode options can be coupled with the Sn anode.

Due to their low cost, high safety, and high energy density, rechargeable aqueous batteries based on Sn anodes can find applications in the transportation sector (electric vehicles), the residential sector (home storage of energy generated by photovoltaics), and grid scale energy storage.

Efforts to develop advanced Li-ion batteries will not meet the metrics for mass adoption of renewables. In addition they utilize expensive components (cobalt based cathodes and carbonate electrolytes) and suffer from safety issues due to the flammability of the electrolytes, the large voltages of the cells, and the toxicity of the components. Aqueous batteries provide a significantly safer and less-expensive option if the energy densities can be increased to compete with Li-ion batteries.

Three main aqueous batteries include: (1) the alkaline battery based on a zinc (Zn) anode, MnO₂ cathode, and highly basic electrolyte which has mass market penetration but is generally considered non-rechargeable; (2) the lead-acid battery based on a lead anode (Pb), lead oxide cathode (PbO₂), and highly acidic electrolyte. This battery is highly rechargeable but suffers from very low energy density due to the weight of the lead based electrodes; (3) the nickel metal-hydride battery based on a NiOOH cathode and Ni-based alloy anode that incorporates hydrogen atoms upon charging. This battery is highly rechargeable but suffers from low energy density due to the weight of the anode and constrained capacity of the cathode. All three of these aqueous batteries have constrained cycleabilities due to unwanted side reactions that deteriorate the reversibility of the electrodes.

Embodiments described herein based on the Sn anode has significantly higher energy density than other electrodes used in aqueous batteries which indicates that it is a viable option to improve upon and replace Li-ion batteries as the dominant renewable energy storage technology.

Some embodiments include an aqueous rechargeable battery comprising: an anode including tin; a cathode; and an aqueous electrolyte disposed between the anode and the cathode. In some embodiments, the anode includes shells encapsulating the tin. For example, the shells may be a conductive support, such as carbonaceous shells. In some embodiments, the shell is less than about 10 nm thick (e.g., less than about 10, 9, 8, 7, 6, 5, 4 nm thick). In some embodiments, the anode includes encapsulating the tin in a conductive network of, e.g., carbonaceous material. In some embodiments, the tin that is encapsulated in shells or a conductive network has a diameter of less than about 200 nm (e.g., less than about 200, 150, 100, 70, 50, 40, 30 nm). In some embodiments, the aqueous electrolyte is acidic (e.g., a pH of about 0, 1, 2, 3, 4, 5 or 6). In some embodiments, the cathode includes manganese oxide.

Other embodiments include a method of making a Sn anode material comprising forming tin oxide nanoparticles and coating the tin oxide nanoparticles with a conductive support. In some embodiments, the method results in encapsulated tin nanoparticles of the above embodiments. For instance, in some embodiments, the conductive support is a shell encapsulating the tin oxide. In some embodiments, the shell is a carbonaceous shell. In some embodiments, the shell is less than 10 nm thick. In some embodiments, the tin oxide nanoparticles are less than 100 nm in diameter.

### Examples

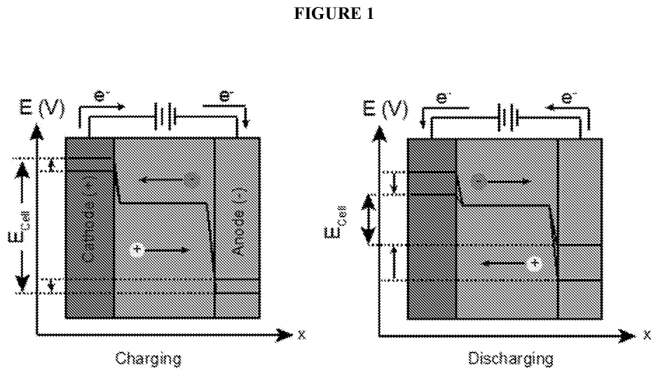

This disclosure relates, in part, to energy dense rechargeable aqueous batteries. A battery stores electrical energy in the chemical bonds of two differing electronically and often ionically conducting materials, or electrodes, separated by an electronically insulating and ionically conducting electrolyte. The energy difference of the electrons in the electrodes establishes an electric field, or voltage, across the battery. During operation, current is generated when the electrons in the anode (or negative electrode) of the battery move through an external circuit performing work on an external load and end up in the cathode (or positive electrode). Simultaneously, ions in the electrolyte migrate through the battery from one electrode to the other to complete the circuit. This process continues until the energy of the electrons in both electrodes are equal to each other and there is no longer an electric field. In addition, it is especially useful if this process can by reversible such that energy generated by an external source can re-establish the initial electric field and the battery can be recharged and used to store and deliver energy many times. These processes are summarized in FIG. 1.

In designing the next generation of electrochemical energy storage technology, it is useful to look on the development of battery chemistries since the first battery, the Volta pile, was discovered in the late 1700's. The Volta pile made use of either copper or silver metal cathodes and zinc metal anodes separated by cloth or cardboard soaked in a salt-water electrolyte. This battery was not rechargeable and generated a voltage of 0.76 V through the reactions of Zn→Zn²⁺+2e⁻on the anode and 2H⁺+2e⁻→H₂ on the cathode. Thus, it was soon realized that the chemical composition of the cathode was not important to the operation of the battery and could be replaced by other inert electronically conductive metals. Recognizing the importance of storing energy in the electrode itself, the Daniell cell soon replaced the Volta cell. In this iteration, the anode still made use of the Zn²⁺/Zn redox couple, but the electrolyte was replaced with CuSO₄ such that the cathodic reaction was now Cu²⁺+2e⁻→Cu, producing a cell with a voltage of about 1.1 V. For the next 100 years, a number of primary (or non-rechargeable) batteries were developed that iterated on the Volta and Daniell cell designs with differing metal compositions for the electrodes and aqueous based electrolytes with one or more dissolved ionic species corresponding to the elements of the electrodes. Modern primary aqueous batteries, the so-called alkaline batteries, make use of a zinc anode and an MnO₂ cathode with a strongly alkaline electrolyte. These batteries have high gravimetric and volumetric capacities but are not rechargeable. Still, due to their low cost they maintain dominance in global market share of battery technologies. They are based on an early battery design, the Leclanché cell, which first described the use of a MnO₂ cathode.

The first rechargeable battery, the lead-acid battery, was introduced in 1859 and used a Pb/PbSO₄ anode and a PbSO₄/PbO₂ cathode. Despite its heavy weight, it could provide a high current and be recharged many times and is still used today for starting gas powered automobiles. However, due to its weight, the lead-acid battery is not a viable technology to replace gasoline engines as the primary energy source for automobiles. Efforts to reduce the weight of the active components have developed multiple rechargeable aqueous batteries, including the nickel metal hydride battery which is used in hybrid electric vehicles such as the Toyota Prius. This battery uses a highly alkaline electrolyte, a hydrogen alloying anode (generally composed of an alloy of mixed transition metals such as Ni_{3.69}Co_{0.72}Mn—_{0.4}Al_{0.21}Xₙ—H₅) and a NiOOH cathode. Despite the significant improvement in energy density compared to lead-acid batteries, because the NiOOH cathode exchanges just 1 e⁻per formula unit during charge/discharge and the anode is quite heavy, this battery is not a competitive replacement for gasoline engines.

The modern rechargeable Li-ion battery was developed in the 1980's through work by John Goodenough. Recognizing that the energy density of the battery scaled with the voltage of the cell, Goodenough, improved upon the chalcogenide LiTiS₂ cathode developed by M. Stanley Whittingham by switching the anion sulfur ligands to oxides and developing the LiCoO₂ cathode that is still used today. During discharge, the battery operates by shuttling Li ions out of a graphite anode and intercalating those ions into the CoO₂ cathode: LiC₆+CoO₂→C₆+LiCoO₂, E_{cell} of about 4.0V. Due to their high capacities and energy density, Li-ion batteries have become the dominant technology in portable electronics and electric vehicles. Still, despite decade of research and development, the modern Li-ion battery has made only marginal improvements in energy density and falls short of what is specified to replace the gasoline engine.

Primarily, efforts to improve the energy density of Li-ion batteries have focused on raising the voltage of the cathode and replacing cobalt with less expensive transition metals such as nickel. The downside to this approach is the criterion to use non-aqueous electrolytes which suffer from decomposition during use and the possibility of thermal runaway which introduces significant safety concerns due to the flammability of the electrolyte. In addition, recent approaches to increase the capacity of the cathodes through redox reactions of the oxygen ligands of the electrode lead to large irreversibility and voltage fade during use. Future Li-ion cathodes are expected to use lower voltage materials with much higher capacities why rely on conversion reactions rather than intercalation reactions. However, targeted materials such as CuF₂ and FeF₃, suffer from low cyclability and high cost due to the use of fluorine containing precursors during synthesis. While these cathodes are attractive alternatives to the intercalation cathodes, their development is still very much in its early stage and the high cost may prevent their widespread use. Efforts are also underway to transition from the graphite anode to higher capacity anodes such as silicon or lithium metal. These electrodes are expected to lead to higher specific energies but suffer from their own problems such as structural degradation due to volume expansion/contraction upon lithiation/delithiation and the formation of dendrites that may cross to the cathode and short the cell. In addition, as the energy density of the Li-ion battery is primarily cathode constrained, the expected gains in switching to these anode chemistries are expected to be modest.

How then should one design a battery that can effectively transition the planet to renewable energy? It is clear that future rechargeable batteries should have high specific energies and energy densities, fast charge/discharge times, non-toxic chemistries, and be highly affordable. The U.S. Department of Energy has outlined certain benchmarks in energy storage to satisfy these criteria. These include goals of improved battery chemistry and cell technologies for grid storage that lower costs to $80/kWh at the pack level, for transportation that increase the energy density to 1 kWh/L, for aviation that increase specific energy to 500 Wh/kg, and decrease charge times to 15 minutes or less. Ultimately, despite significant efforts in research and development, Li-ion intercalation-based batteries still fall short of these goals. Even with efforts to develop Li metal anodes, the capacities of Li-intercalating metal oxide cathodes will not reach these goals unless significantly improved chemistries are discovered.

Aqueous rechargeable batteries are an attractive alternative. While they do not approach the operating voltages of Li-ion batteries due to the narrower stable voltage range of water, the electrode capacities can exceed those used in Li-ion batteries by using multi-electron conversion or formation electrodes. Benefits to this approach are significantly reduced cost, improved safety, and the potential for energy densities that exceed the best performing Li-ion intercalation batteries. However, as mentioned above, the rechargeability and rate capabilities of commercialized aqueous batteries (such as Pb-Acid and Zn—MnO₂ alkaline batteries) are still poor and require innovative strategies for improvement.

### Designing for Affordability

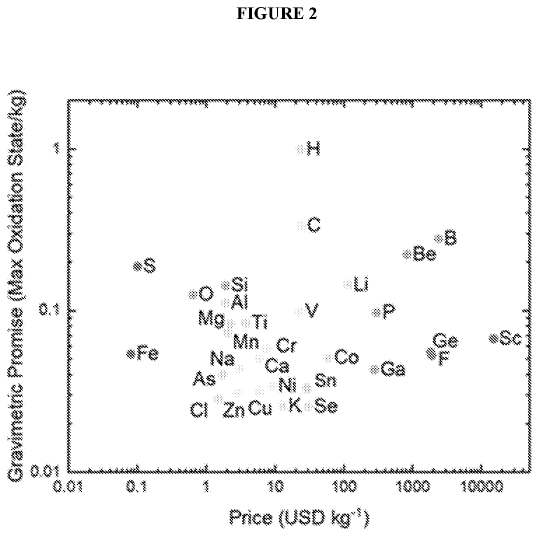

Commercialized rechargeable aqueous batteries are not competitive replacements for Li-ion batteries due to the low specific capacities of the cathodes. The origin of these low specific capacities generally results from single electron conversions per formula unit (such as about 305 mAh/g for MnO₂e⁻→MnOOH in Zn—MnO₂ alkaline batteries) or because of the high molar mass of the electrodes (for example about 177 mAh/g for PbO₂+2e⁻→PbSO₄ in Pb-Acid batteries). To identify competitive chemistries, a metric “Gravimetric Promise” can be specified. This metric considers the maximum (or minimum) oxidation state of the element based on its weight. When plotted versus the raw material cost of the element one can highlight promising chemistries, shown in FIG. 2. Some promising elements, such as H, O, and Cl are gases at ambient conditions, while other such as C produce gases (CO₂) during charging. Others, such as and Cr are too toxic to be widely used. Those with a raw material price >50$/kg are (where Co is the dividing line) do not meet the economic demands for worldwide utility. Lastly, electronically insulating phases such as S, Se, or SiO₂ will have constrained charge/discharge efficiencies.

The next step is analyzing the standard reduction potentials and gravimetric capacities of the elements (or their oxides) and comparing them to the stable voltage window for water. The gravimetric capacity (Q) is calculated as, where F is Faraday's constant, W is the formula unit weight of the electrode, and n is the number of electrons transferred per formula unit:

$$Q = \frac{nF}{3.6 W} \qquad ( 1 )$$

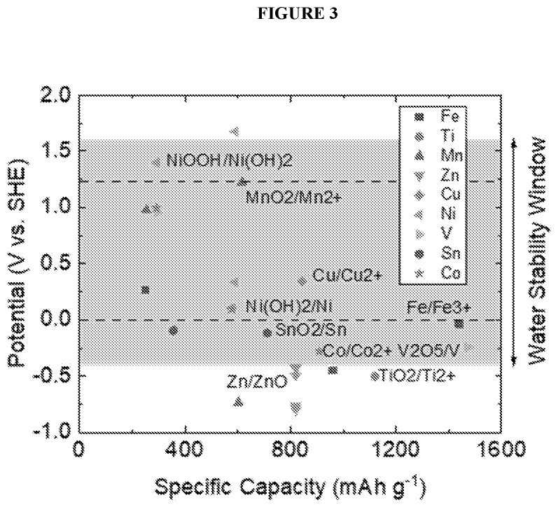

Water can decompose into H₂ gas at potentials <0 V vs. RHE and into oxygen gas at potentials >1.23 V vs. SHE. However, these reactions specify catalysts to proceed efficiently and thus the voltage window of water-based electrolytes may be extended to approximately −0.4 V to 1.6 V vs. SHE. The capacities in the oxidized state and voltage for redox couples (within the range of −1.0 V to 2.0 V vs. SHE) based on the elements Fe, Ti, Mn, Zn, Cu, Ni, V, Sn, and Co are shown in FIG. 3. The water stability window is highlighted in blue. Materials that are a solid in one half of their redox couple are considered (the other redox couple may be a dissolved ionic species).

### Multi-Electron Formation Electrodes for Rechargeable Aqueous Batteries

### MnO₂ Cathodes in Acidic Electrolyte

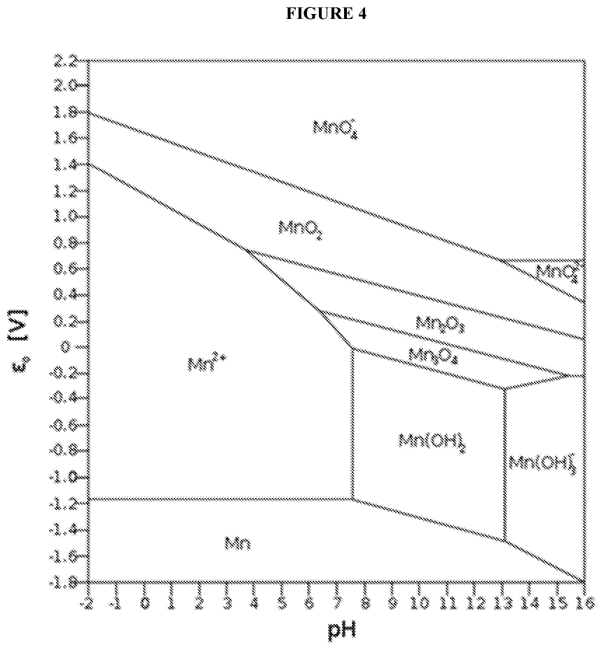

Maximizing the energy density of rechargeable aqueous batteries specifies a cathode with a reduction potential near 1.23 V and the use of multiple electron transfer reactions per formula unit. Due to its low cost and low toxicity, this disclosure focuses on the use of manganese as a cathode. The Pourbaix diagram which shows the phase stability versus pH and potential for the Mn—H_{O} system is shown in FIG. 4. The use of MnO₂ is established in primary alkaline cells, but is not rechargeable due to the many redox reactions MnO₂ goes through as it is discharged, where MnO₂ is successively converted to Mn₂O₃, then Mn₃O₄, then the soluble Mn(OH)₃⁻anion. Because of this, rechargeable alkaline cells generally use up to 0.5 electrons per MnO₂ formula unit thereby constraining their energy densities. Inspired by the approach of the lithium metal anode for Li-ion batteries, the electrodeposition/stripping of MnO₂ in acid is considered (Mn²⁺+2H₂O→MnO₂+4H⁺; about 616 mAh/g, E⁰=1.224 V vs. SHE). The deposition process is established for the production of electrolytic manganese dioxide (EMD) used in alkaline primary batteries and produces films with even morphologies free from the dendritic growth problems that plague Li metal anodes. Because the standard reduction potential for MnO₂+4H⁺+2e⁻→Mn²⁺+2H₂O (E0=1.224 V vs. SHE) is below the standard reduction potential for O₂+4H⁺+4e⁻→2H₂O (E⁰=1.229 V vs. SHE), the MnO₂ cathode is stable in acidic electrolytes and does not corrode through the generation of oxygen gas.

### Rechargeable Formation Anodes in Acidic Electrolyte

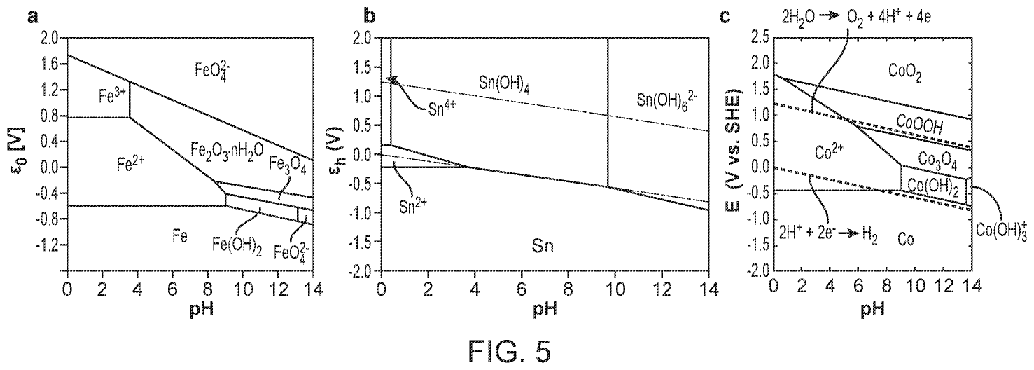

Rechargeability in commercial aqueous batteries based on Zn anodes is poor due to the low reduction potential of ZnO (ZnO+H₂O→Zn2OH⁻;E⁰=−0.434 V vs. RHE) which results in unwanted side reactions from the generation of hydrogen gas during charging (2H₂O→H₂+2OH⁻;E⁰=0 V vs. RHE). In addition, ZnO forms the soluble zincate anion Zn(OH)₄²⁻during charging/discharging which results in active material loss and low cycle life. These problems are worsened in acidic electrolytes where spontaneous H₂ evolution occurs through corrosion and dissolution of the Zn anode. As such, new conversion anodes that are stable in acid should be explored. Based on FIG. 3, 3 suitable anode systems are identified based on Fe, Sn, or Co. Their Pourbaix diagrams are presented in FIG. 5. The vanadium electrode was not considered as it suffers from spontaneous dissolution through H₂ production.

Of these three options, the Fe²⁺/Fe and Co²⁺/Co reduction potentials are at or below the limit of the maximum stable voltage window for aqueous electrolytes. Thus, the Sn electrode is the most promising focus. Although the energy density is lower than the Zn, Fe, and Co anodes due to a higher reduction potential for SnO₂ (SnO₂ (SnO₂+4H⁺+4e⁻→Sn+2H₂O; E⁰=−0.094 V vs. SHE), unwanted side reactions due to H₂ generation and Sn dissolution are significantly reduced which will improve the stability and cycle life of the anode.

### Technoeconomic Analysis of Sn—MnO₂ Battery

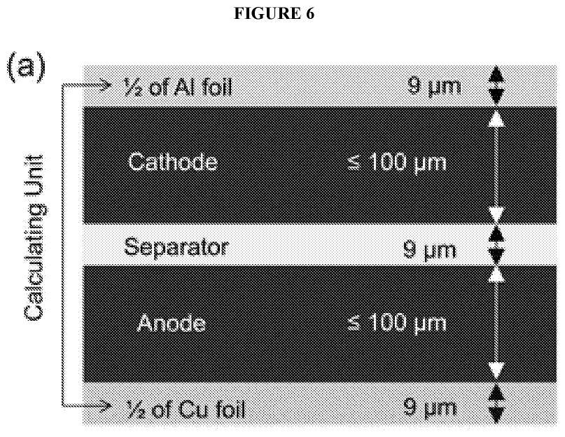

To determine if the Sn—MnO₂ acidic battery is a viable improvement upon Li-ion batteries, the cost, specific energy, and energy densities were evaluated at the pack level and compared to the Li-ion based battery systems modeled therein. The calculating unit is presented in FIG. 6. The electrodes have the thicknesses displayed in the diagram and projected geometric areas of 1 cm². The capacity constrained electrode is assumed to be 100 μm thick and the other electrode is capacity matched. For both electrodes, the active material is assumed to compose 60% of the volume with the other 40% composed of a binder and conductive additives with an average density of 1.6 g/cm³. The weight of the separator is omitted from the calculation. The aluminum and copper foils do not contribute capacity or voltage to the cell. No cost is attributed to the separator, binder, conductive additives, or electrolyte. The specific energy (Eₛ) of the cell can be calculated through the following formula, where V is the average cell operating voltage, ρᵢ is the density of the i electrode, Q is the gravimetric capacity of the limiting electrode, tᵢ is the thickness of layer i in FIG. 6, and A is the projected area of the electrodes (1 cm²). The subscript lim, cat, an, and sep, refer to the capacity constrained electrode, the cathode, the anode, and the separator respectively:

$${E}_{s} = \frac{0.6 {t}_{lim} A {ρ}_{lim} QV}{A ( \text{?} )} \qquad ( 2 )$$

$$\text{?} \text{indicates text missing or illegible when filed}$$

The energy density (E_{d}) of the cell is calculated as:

$${E}_{d} = \frac{0.6 {t}_{lim} A {ρ}_{lim} QV}{A ( {t}_{Al} + {t}_{Cu} + {t}_{cat} + {t}_{an} + {t}_{sep} )} \qquad ( 3 )$$

The cost of the cell is based on the raw material cost for the weight loading of the separate components based on the price of their elements (Table 1).

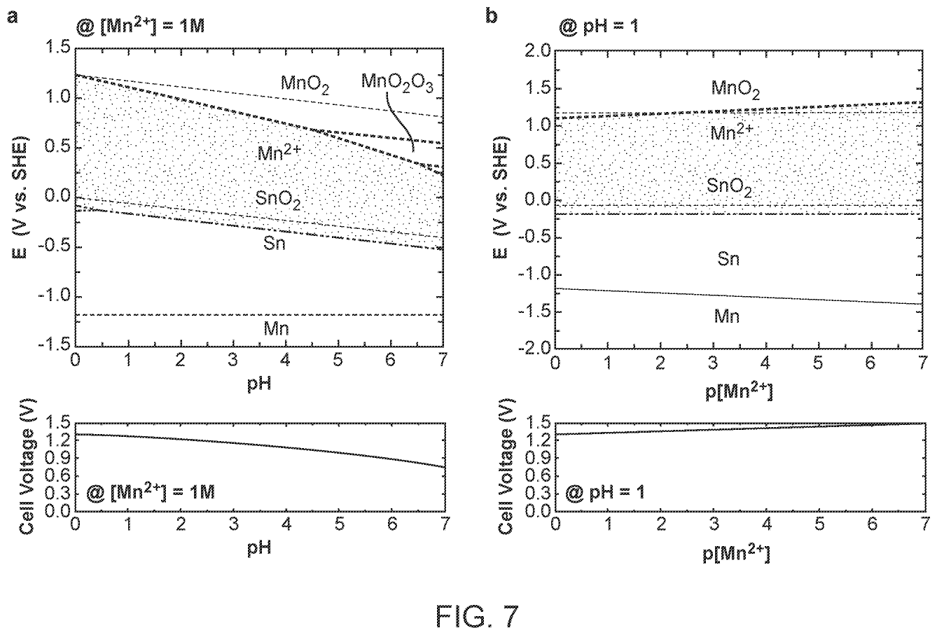

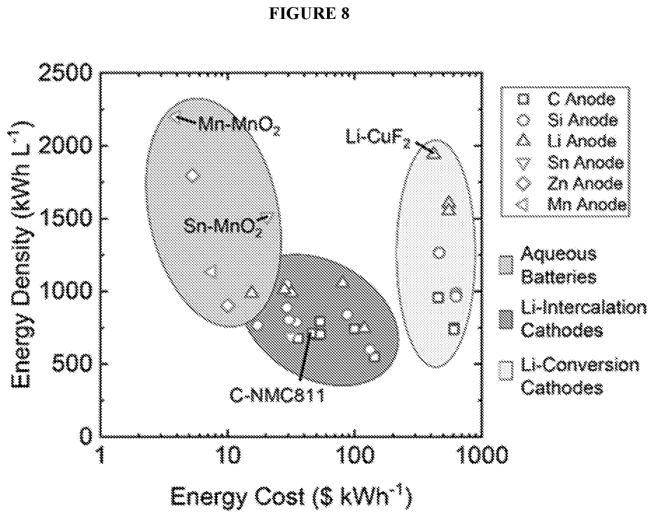

For aqueous batteries, the voltage is a function of the pH of the electrolyte and the concentration of the metal salt (in this case Mn²⁺for the MnO₂/Mn²⁺electrode). FIG. 7 shows the relationship of the standard reduction potentials for the MnO₂/Mn²⁺and SnO₂/Sn electrodes versus pH and versus p[Mn²⁺] and the relative stability of the phases. Similar relationships can be derived for other aqueous anode options including Mn and Zn. Table 1 lists the standard reduction potentials (pH=0 and p[M⁺]=0) for aqueous and Li-ion battery electrodes as well as their gravimetric and volumetric capacities. The voltages are scaled to the Li⁺/Li reference potential for ease of comparison. FIG. 8 compares the cost to store the energy for different battery systems (separated into Li-ion intercalation, Li-ion conversion, and aqueous batteries) versus their volumetric energy densities.

TABLE 1
Formula mass, densities, capacities, standard reduction
potentials, and cost of battery electrodes

| | | | Gravimetric | Volumetric | Voltage | |
|---|---|---|---|---|---|---|
| | M | Density | Capacity | Density | (Vs. | |
| | (g/mol) | (g/cm3) | (mAh/g) | (mAh/cm³) | Li+/Li) | $/kg |
| Li | 6.94 | 0.534 | 3861.872 | 2062.239 | 0 | 115.7 |
| LiC₆ | 79.00 | 2.23 | 339.2581 | 750.5455 | 0.1 | 32.05567 |
| Li₄Si | 55.85 | 0.63 | 1919.698 | 1209.41 | 0.3 | 58.47389 |
| Zn | 65.38 | 7.14 | 819.8651 | 5853.837 | 2.2782 | 2.83 |
| Sn | 118.71 | 7.31 | 903.0878 | 6601.572 | 2.923 | 20 |
| Mn | 54.94 | 7.43 | 975.6958 | 7249.42 | 1.855 | 2.06 |
| Li₂O₂ | 45.88 | 2.31 | 1168.377 | 2698.95 | 2.65 | 35.45043 |
| LiOH | 23.95 | 1.46 | 1119.196 | 1634.026 | 2.65 | 34.95329 |
| FePO₄ | 150.82 | 3.056 | 177.7104 | 543.0829 | 3.3 | 61.91396 |
| Li_{0.5}CoO₂ | 90.93 | 4.78 | 147.3721 | 704.4387 | 3.8 | 38.91425 |
| Li_{0.5}Ni_{0.8}Co_{0.15}Al_{0.05}O₂ | 89.14 | 4.45 | 150.3301 | 668.9691 | 3.7 | 11.3024 |
| Li_{0.5}Ni_{0.8}Mn_{0.1}Co_{0.1}O₂ | 90.34 | 4.65 | 148.3365 | 689.7648 | 3.7 | 9.009993 |
| Li_{0.5}MnO₂ | 86.94 | 5.03 | 154.1444 | 775.3462 | 3.3 | 1.537349 |
| FeF₃ | 112.84 | 3.87 | 712.5565 | 2757.594 | 2.5 | 959.7131 |
| CuF₂ | 101.54 | 4.23 | 527.8877 | 2232.965 | 3.3 | 714.6533 |
| MnF₃ | 111.93 | 3.54 | 718.3305 | 2542.89 | 2.5 | 968.461 |
| MnO₂ | 86.93 | 5.03 | 616.5775 | 3101.385 | 4.264 | 1.537349 |
| Al | 26.98 | 2.7 | | | | 1.91 |
| Cu | 63.55 | 8.96 | | | | 5.9 |

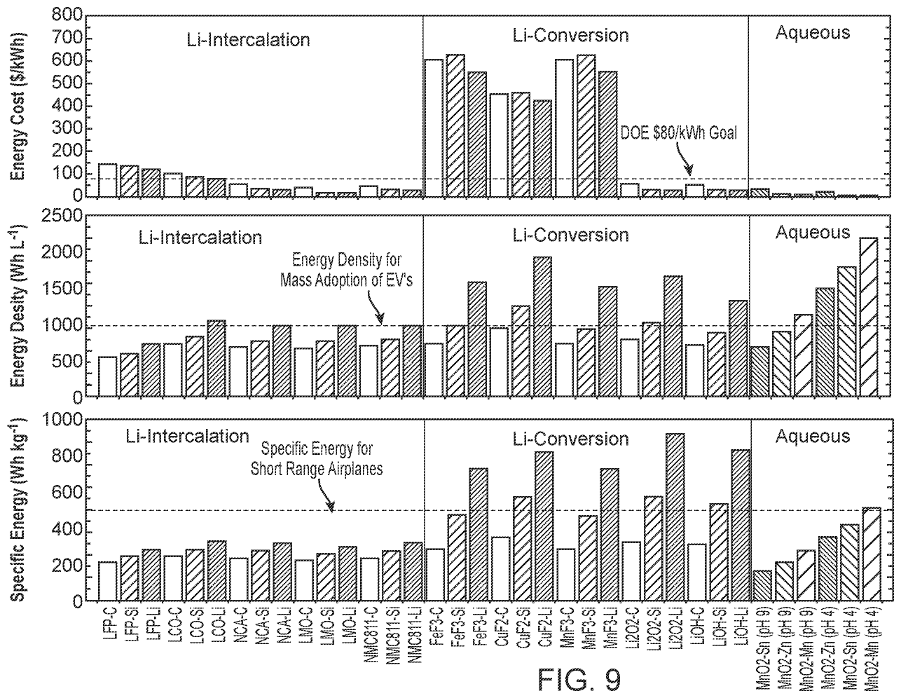

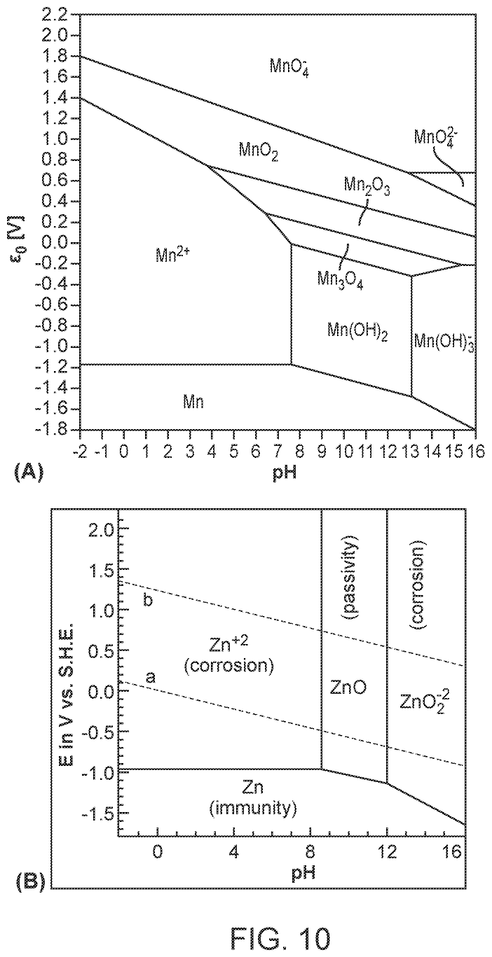

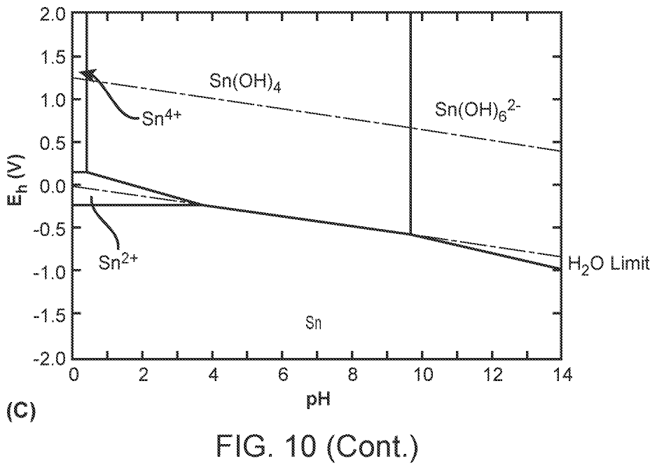

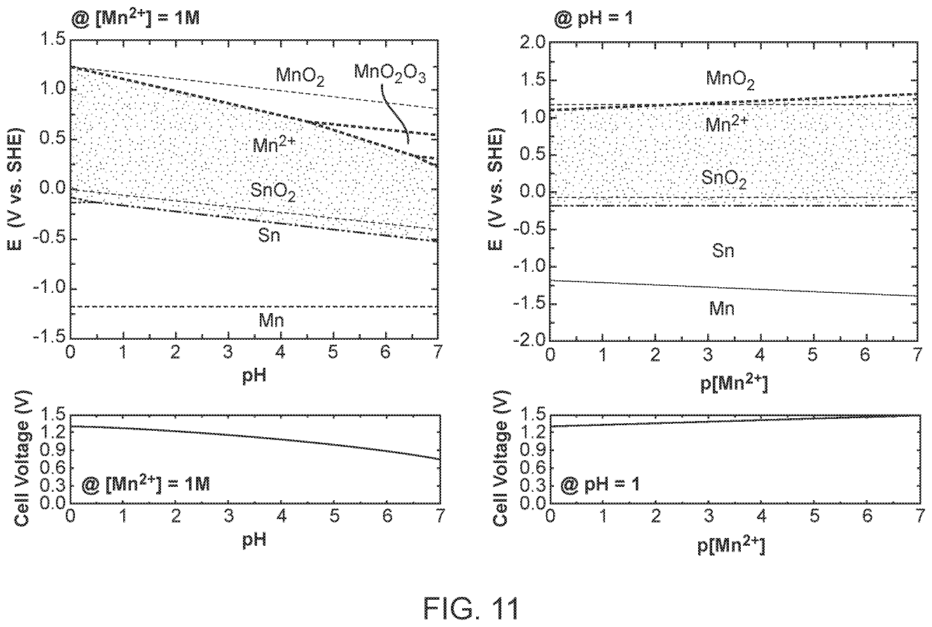

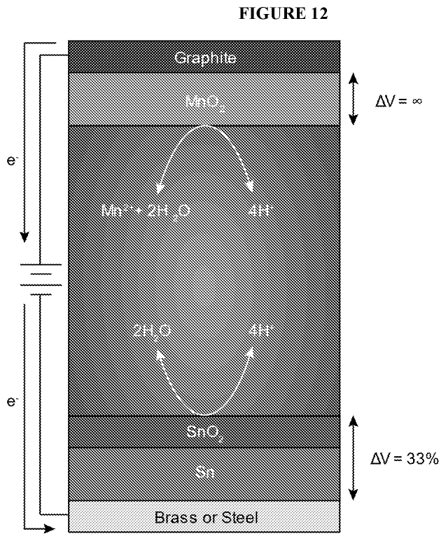

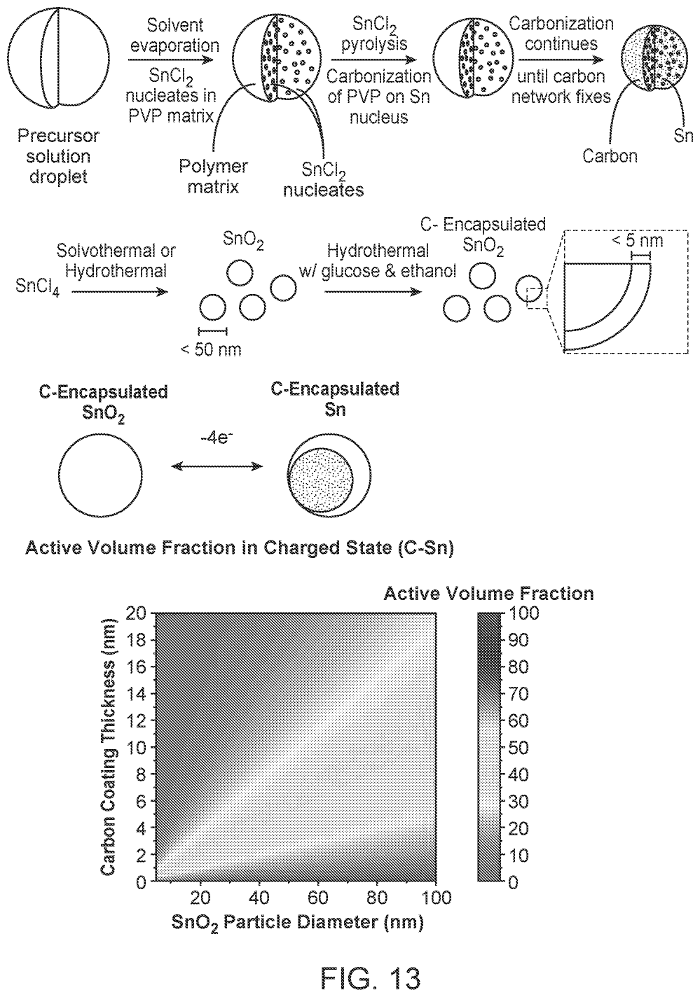

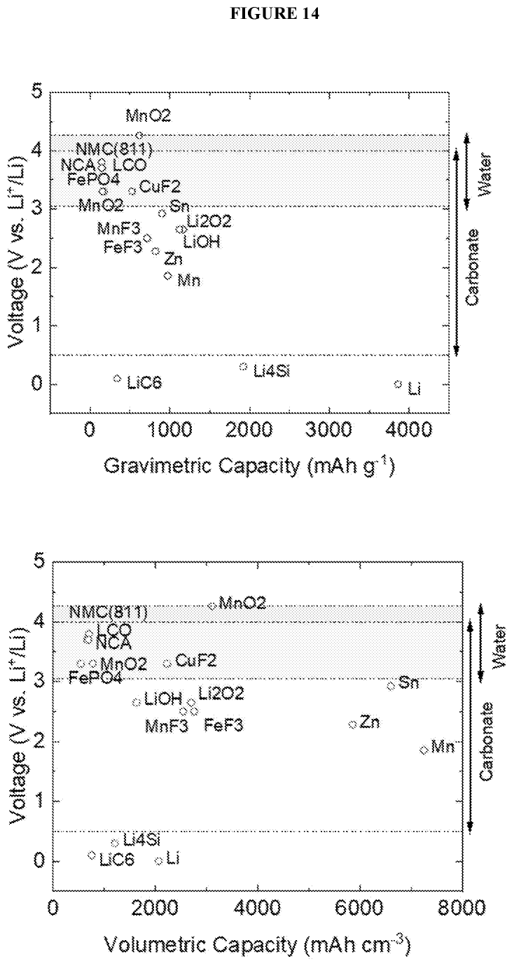

The relevant energy metrics including specific energy, energy density, and energy cost for the battery systems in Table 1 are shown in FIG. 9. There is a great benefit to switching the aqueous electrolyte from alkaline to acidic conditions where the MnO₂ electrode can store up to 2 e⁻per formula unit. The Zn and Mn anode systems are included as a comparison but it is unlikely that these anodes can be efficiently developed as their reduction potentials are more than 500 mV negative of the hydrogen evolution potential (0 V vs. SHE, 3.04V vs. Li/Li⁺).

As a result, a 1.25V Sn-MnO₂ battery using an acidic electrolyte with a pH between 1-4 is a focus of an embodiment. This battery can theoretically store energy at a cost of about $20/kWh, a specific energy of about 329 Wh/kg, and an energy density of about 1409 kWh/L. Although the specific energy of this battery is lower than the 500 Wh/kg goal for aviation, the cost and energy density reach the goals set forth by the DOE and beat all Li-ion intercalation-based battery systems.

As used herein, the singular terms “a,” “an,” and “the” include plural referents unless the context clearly dictates otherwise. Thus, for example, reference to an object can include multiple objects unless the context clearly dictates otherwise.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially,” “substantial,” “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 5, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. An aqueous rechargeable battery comprising:
an anode including tin;
a cathode; and
an aqueous electrolyte disposed between the anode and the cathode.

2. The aqueous rechargeable battery of claim 1, wherein the anode includes shells encapsulating the tin.

3. The aqueous rechargeable battery of claim 2, wherein the shells are carbonaceous shells.

4. The aqueous rechargeable battery of claim 1, wherein the aqueous electrolyte is acidic.

5. The aqueous rechargeable battery of claim 4, wherein the aqueous electrolyte has a pH in a range of about 1 to about 4.

6. The aqueous rechargeable battery of claim 1, wherein the cathode includes manganese oxide.

7. A method of making a Sn anode material comprising forming tin oxide nanoparticles and coating the tin oxide nanoparticles with a conductive support.

8. The method of claim 7, wherein the conductive support is a shell encapsulating the tin oxide.

9. The method of claim 8, wherein the shell is a carbonaceous shell.

10. The method of claim 8, wherein the shell is less than 10 nm thick.

11. The method of claim 7, wherein the tin oxide nanoparticles are less than 100 nm in diameter.

12. The aqueous rechargeable battery of claim 2, wherein the aqueous electrolyte is acidic.

13. The aqueous rechargeable battery of claim 3, wherein the aqueous electrolyte is acidic.

14. The method of claim 9, wherein the shell is less than 10 nm thick.

15. The method of claim 8, wherein the tin oxide nanoparticles are less than 100 nm in diameter.

16. The method of claim 9, wherein the tin oxide nanoparticles are less than 100 nm in diameter.

17. The method of claim 10, wherein the tin oxide nanoparticles are less than 100 nm in diameter.
